(19) United States
(12) Patent Application Publication
(10) Pub. No.: US 2007/0187613 A1
(43) Pub. Date: Aug. 16, 2007

(54) Method for supporting an electrode

(76) Inventor: Jukka Olavi Kahilainen, Solana Beach, CA (US)

Correspondence Address: NEIL K. NYDEGGER;NYDEGGER & ASSOCIATES, 348 Olive Street, San Diego, CA, 92103, US

(21) Appl. No.: 11/356,353

(22) Filed: Feb. 16, 2006

(51) Int. Cl. H01J 47/00

(52) U.S. Cl. 250/389

(57) ABSTRACT

A mechanism for supporting a charge collecting electrode in the chamber of an ion detector includes an insulator that is mounted in the chamber and is attached to the electrode. A first magnet is used to establish a magnetic field in the chamber, and a second magnet is attached to the electrode. The magnet on the electrode then interacts with the magnetic field to stabilize the electrode in the chamber between the insulator and the first magnet.

### FIELD OF THE INVENTION

The present invention pertains generally to charged particle (e.g. ion) detectors. More specifically, the present invention pertains to charged particle detectors which include electrodes that are suspended in a plasma or gas containing the charged particles that are to be detected. The present invention is particularly, but not exclusively, useful as a charged particle detector which includes an electrode that is affixed to only a single support structure inside the ionization chamber of an ion detector.

### BACKGROUND OF THE INVENTION

It is well known that there are many scientific and commercial purposes for collecting charged particles (e.g. ions). Regardless of the particular nature of the particles, or the intended function of the collection process, it has generally been the common practice to collect charged particles with a device that incorporates an electrode. Typically, the electrodes that are most effectively employed for this task are thin, elongated conductor wires. When in use, these electrodes must somehow be suspended inside the chamber where the particles are to be collected. Due to the rather insubstantial nature of the electrodes, however, it has also been necessary to somehow ensure that the electrodes are stabilized during a charged particle collection process.

Heretofore, the stabilization of an electrode in the chamber of an ion detector has been accomplished by anchoring the electrode in the chamber at two or more separated points. For the specific case wherein the electrode is a wire, this has been accomplished by anchoring the respective ends of the electrode wire to the ionization chamber wall. In any event, at each anchoring point, there is a need to provide a standoff insulator that will electrically insulate the electrode (e.g. wire conductor) from the chamber wall to which it is anchored. As a practical matter, however, each standoff insulator will inherently increase the probability of capacitance losses and current leakage in the electrode. Additionally, the use of additional standoff insulators necessarily increases the cost of the ion detector.

In light of the above, it is an object of the present invention to provide a mechanism for supporting a charge collecting electrode in the chamber of an ion detector which has only a single attachment between the electrode and the chamber. Another object of the present invention is to provide a mechanism for supporting a charge collecting electrode in the chamber of an ion detector which effectively minimizes capacitance losses and current leakage in the electrode. Yet another object of the present invention is to provide a mechanism for supporting a charge collecting electrode in the chamber of an ion detector which is relatively easy to manufacture, is simple to use, and is comparatively cost effective.

### SUMMARY OF THE INVENTION

In accordance with the present invention, a mechanism for supporting a charge collecting electrode, in the chamber of a charged particle (e.g. ion) detector, includes an insulator that is mounted on the chamber wall. More specifically, the electrode is attached to the insulator inside the chamber. In the typical case, wherein the electrode is a thin, elongated wire conductor, one end of the electrode is attached to the insulator, while the rest of the electrode is freely suspended in the chamber. For the present invention, a permanent magnet is attached to the free end of the electrode.

It is an important aspect of the present invention that, apart from the permanent magnet on the electrode, another magnetic field is also somehow created in the chamber. Preferably, this magnetic field is centered on the chamber wall, and is positioned across the chamber from the insulator. For the purposes of the present invention, this additional magnetic field can be created by another permanent magnet that is mounted on the chamber wall. Alternatively, it may be created by the chamber wall, itself. In either case, it is the intent of the present invention that the permanent magnet, which is attached to the electrode, will interact with the magnetic field created at the wall of the chamber to stabilize the electrode in the chamber.

In addition to the structure disclosed above, the detector of the present invention also includes a preamplifier. Specifically, an input pin is provided at the insulator to electrically connect the electrode in the chamber with the preamplifier that is positioned outside the chamber. With this combination of structure, the electrode of the present invention has only a single insulated point of engagement with the chamber; but it is directly connected with the preamplifier for detecting charged particles in the chamber.

For the operation of the present invention, the detector may be any type of charged particle detector that is presently known in the pertinent art. For instance, the detector may be either an ionization chamber or a gas proportional counter. Further, and despite the type detector being used, a plurality of charge collecting electrodes may be employed in the chamber, and interconnected with respective components as mentioned above, for the purpose of collecting charge particles.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a system for collecting charged particles; and

FIG. 2 is a cross-sectional view of the chamber of the system as seen along the line 2-2 in FIG. 1.

### DESCRIPTION OF THE PREFERRED EMBODIMENTS

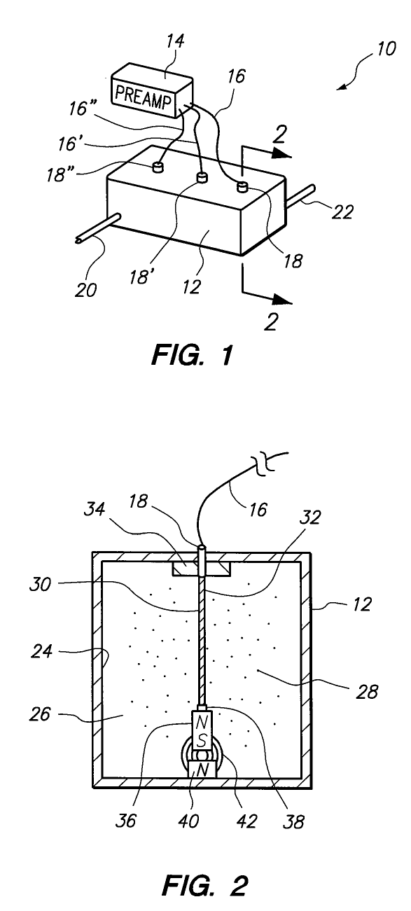

Referring initially to FIG. 1, a system incorporating the present invention for collecting charged particles is shown and generally designated 10. In FIG. 1 it is shown that the system 10 includes an ionization chamber 12 that is connected with a preamplifier 14. Specifically, the connection between the preamplifier 14 and the chamber 12 includes a connecting line 16 that runs from the preamplifier 14. The connecting line 16, in turn, is electrically interconnected with an input pin 18 on the chamber 12. FIG. 1 also indicates that the chamber 12 can have a gas input 20 and a gas output 22 which are similar to that of other ionization chambers well known in the pertinent art.

Referring now to FIG. 2, it will be seen that chamber 12 has an inside chamber wall 24 that defines an interior chamber 26. As intended for the present invention, the chamber 12, with its interior chamber 26, must be of a type well known in the pertinent art that is capable of containing a plurality of charged particles 28. Further, for the purposes of the present invention, it is anticipated that the charged particles 28 will, most likely, be ions. In any event, the system 10 for the present invention includes an electrode 30 that is positioned inside the interior chamber 26 for collecting the charged particles 28. Insofar as the electrode 30 is concerned, for the system 10, the electrode 30 will most likely be a thin wire electrode of a type well known in the pertinent art.

As shown in FIG. 2, an end 32 of the electrode 30 is attached to a standoff insulator 34. In detail, the standoff insulator 34 is of a type well known in the art and is mounted on the inside chamber wall 24. As will also be appreciated by the skilled artisan, the purpose of this standoff insulator 34 is to electrically isolate the electrode 30 from the chamber wall 24. On the other hand, the electrode 30 is electrically connected to the input pin 18 at the insulator 34. Thus, through the input pin 18 and the connecting line 16, the electrode 30 is also electrically connected with the preamplifier 14.

Still referring to FIG. 2, the system 10 of the present invention further includes a permanent magnet 36 that is shown affixed to an end 38 of the electrode 30. As shown, the end 38 of electrode 30 is opposite from the end 32. Unlike the end 32, however, the end 38 of electrode 30 has no connecting structure and, thus, is freely disposed in the interior chamber 26. FIG. 2, however, also shows that a magnet 40 is positioned on the inside chamber wall 24. Specifically, it is intended that the magnet 40 will create a magnetic field 42 which interacts with the permanent magnet 36 affixed to the end 38 of electrode 30. The specific purpose of this interaction is to hold the end 38 of electrode 30 stationary, and thereby stabilize the electrode 30 in the interior chamber 26. It is to be appreciated that the polarities “N” and “S” shown for the magnets 36 and 40 in FIG. 2 are merely exemplary, and could be reversed without decreasing efficacy.

Although the magnet 40 is shown in FIG. 2 to be a permanent magnet that has been mounted on the wall 24, it is to be appreciated that other means may also be used for creating the magnetic field 42. For example, the inside chamber wall 24 may, itself, be magnetized to create the magnetic field 42. In any event, as envisioned by the present invention, a magnetic field 42 is to be created at a location on the inside chamber wall 24 which will effectively position and stabilize the electrode 30 in the interior chamber 26 (e.g. at a location across the interior chamber 26 from the standoff insulator 34). Further, it is envisioned that a plurality of electrodes 30 may be employed for the system 10. Indicative of this, are the additional input pins 18′ and 18″, with their respective connecting lines 16′ and 16″ shown in FIG. 1.

While the particular Method for Supporting an Electrode as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mechanism for supporting a charge collecting electrode in a chamber of an ion detector which comprises:
an insulator means mounted on the detector, in the chamber thereof, and attached to the electrode for holding the electrode;
a magnetic means for establishing a magnetic field in the chamber; and
a permanent magnet attached to the electrode for interacting with the magnetic field to stabilize the electrode in the chamber between the insulator means and the magnetic means.

2. A mechanism as recited in claim 1 wherein the electrode is an elongated wire electrode and has a first end and a second end, with the first end thereof attached to the insulator means, and with the permanent magnet attached to the second end thereof.

3. A mechanism as recited in claim 1 wherein the chamber is filled with a fluid containing charged particles.

4. A mechanism as recited in claim 3 further comprising:
a preamplifier; and
an input pin electrically connecting the electrode with the preamplifier for detecting charged particles in the chamber.

5. A mechanism as recited in claim 1 wherein the chamber of the detector is defined by a wall and the magnetic means is the wall.

6. A mechanism as recited in claim 1 wherein the magnetic means is a permanent magnet.

7. A mechanism as recited in claim 1 further comprising a plurality of charge collecting electrodes.

8. A mechanism as recited in claim 1 wherein the ion detector is an ionization chamber.

9. A mechanism as recited in claim 1 wherein the ion detector is a gas proportional counter.

10. A detector which comprises:
a chamber for receiving a fluid therein, wherein the chamber is defined by a wall and the fluid includes charged particles to be detected;
a charge collecting electrode having a first end and a second end;
an insulator means for affixing the first end of the electrode to the wall of the chamber;
a first magnetic means mounted on the second end of the electrode; and
a second magnetic means positioned on the wall of the chamber for interacting with the first magnetic means to hold the electrode substantially stationary during detection of particles in the chamber with the electrode.

11. A detector as recited in claim 10 wherein the first magnetic means is a permanent magnet.

12. A detector as recited in claim 10 wherein the first magnetic means is the wall.

13. A detector as recited in claim 10 wherein the first magnetic means is a permanent magnet mounted on the wall.

14. A detector as recited in claim 10 wherein the detector is an ionization chamber.

15. A detector as recited in claim 10 wherein the detector is a gas proportional counter.

16. A detector as recited in claim 10 further comprising:
a preamplifier; and
an input pin electrically connecting the first end of the electrode with the preamplifier for detecting charged particles in the chamber.

17. A detector as recited in claim 10 further comprising a plurality of charge collecting electrodes.

18. A method for assembling a charged particle detector which comprises the steps of:
providing a detector having a chamber for receiving a fluid therein, wherein the chamber is defined by a wall and the fluid includes charged particles to be detected;
mounting an insulator means on the wall inside the chamber;
affixing an electrode to the insulator means, wherein the electrode is elongated and has a first end and a second end, and wherein the first end thereof is affixed to the insulator means;
attaching a permanent magnet to the second end of the electrode; and
positioning a magnetic means on the wall of the chamber for interacting with the permanent magnet on the electrode to hold the electrode substantially stationary in the chamber during detection of particles with the electrode.

19. A method as recited in claim 18 further comprising the steps of:
providing a preamplifier; and
electrically connecting the first end of the electrode with the preamplifier for detecting charged particles in the chamber.

20. A method as recited in claim 18 further comprising the step of repeating the mounting step, the affixing step, the attaching step, and the positioning step.
